(19) United States
(12) Patent Application Publication
(10) Pub. No.: US 2004/0230324 A1
(43) Pub. Date: Nov. 18, 2004

(54) Circuit arrangement for remotely powering several local systems via a remotely powered central system

(75) Inventor: Franz Haselsteiner, Leobendorf (AT)

Correspondence Address: HENRY M FEIEREISEN, LLC, 350 FIFTH AVENUE, SUITE 4714, NEW YORK, NY, 10118, US

(73) Assignee: FLEXTRONICS INTERNATIONAL GMBH & CO. NFG. KG, Kindberg (AT)

(21) Appl. No.: 10/800,399

(22) Filed: Mar. 12, 2004

Related U.S. Application Data
(63) Continuation of application No. PCT/AT02/00268, filed on Sep. 16, 2002.

(30) Foreign Application Priority Data
Sep. 20, 2001 (AT) A 1504/2001

(51) Int. Cl. G05B 11/01

(52) U.S. Cl. 700/22; 700/286

(57) ABSTRACT

A circuit arrangement for remotely powering a plurality of local systems, such as network termination units used, for example, with ISDN, from a central unit which itself is remotely powered and a corresponding method for remotely powering the local systems are described. The circuit arrangement includes a power converter receiving remote power from a central exchange, with a processing circuit connected downstream. The power converter provides a supply voltage to the local systems via a first current path and an energy storage unit provides the startup energy the local systems. Switches arranged between the energy storage unit and the local systems individually connect different local systems to the energy storage unit via a second current path. Only a single small energy storage unit is required to supply the startup power.

### CROSS-REFERENCES TO RELATED APPLICATIONS

This application is a continuation of prior filed copending PCT International application no. PCT/AT02/00268, filed Sep. 16, 2002, which designated the United States and on which priority is claimed under 35 U.S.C. §120, the disclosure of which is hereby incorporated by reference.

This application claims the priority of Austrian Patent Application, Serial No. A 1504/2001, filed Sep. 20, 2001, pursuant to 35 U.S.C. 119(a)-(d), the disclosure of which is incorporated herein by reference.

### BACKGROUND OF THE INVENTION

The invention is directed to a system and method for providing remote power to local systems, and in particular to a circuit arrangement for remotely powering several local systems, in particular network termination units, by a central system, which itself is remotely powered.

Circuit arrangements of this type are known, for example, for using a local unit to remotely power ISDN network termination units. The local unit typically has as an energy storage unit a capacitor, which supplies the required startup energy during startup of a new network termination unit. In conventional circuit arrangements the terminals of the individual termination units are disadvantageously coupled with each other via the energy storage unit. This can result in a collapse of the supply voltage for the remaining network termination units during startup of a new network termination unit. This effect can be lessened by using correspondingly larger capacitors which results in large and bulky configurations. Alternatively, each network termination unit can be provided with its own energy storage unit, which however requires a large number of additional components and hence also makes it difficult to fabricate small devices.

Different conventional arrangements for supplying power to several local systems are described with reference to FIGS. 1, 2, 3A, 3B, 4A and 4B.

FIG. 1 shows in a schematic diagram a conventional circuit arrangement for remotely powering several local systems 3 from a central exchange 1. Although the circuit arrangement is described with reference to ISDN network termination units 3, it can be employed with other types of local systems that are remotely powered by a central system. ISDN network termination units 3, also referred to as NT (Network Termination), are typically powered by a local power supply (not shown), which can supply for example 220 volt or 230 volt AC, depending on the local power grid. In general, only the subscriber installation and the subscriber terminals (telephone sets, etc.) (not shown in the figures) a powered by the local power supply, but not the network termination unit 3 itself. The local power supply only supplies power the subscriber installation and terminals via the network termination unit 3. However, in other configurations, the network termination unit 3 itself can also be powered by the local power supply.

The subscriber installation and the terminals can be remotely powered from the network termination unit 3. In this case, the individual telephone sets, etc., need not be connected individually to the power supply. Instead, they can be powered, for example with ISDN, via a phantom circuit represented by the two wires of the subscriber installation (S0 bus). However, this approach for remotely powering the terminals will not be described in detail. In the following, only remotely powering the network termination units 3 themselves will be described.

The ISDN network termination units 3 described hereinafter are representative of an exemplary local system. The network termination units 3 themselves are remotely powered by the central switching station, in the following referred to as central exchange 1. This arrangement is schematically depicted in FIG. 1.

The remote power is supplied from the central exchange 1 via a first interface 4, such as the U_{K0} interface for ISDN. Typically, arrangements are made to power in an emergency, such as a local power failure, a terminal (not shown) in addition to the network termination unit 3. The central exchange 1 can also be remotely powered by the network termination unit 3 during both normal and emergency operation, or only during emergency operation. By remotely powering the network termination unit 3 from the central exchange 1, the network termination unit 3 can operate independently of the local power supply at subscriber location, for example, in an emergency mode in the event of a local power failure. In addition, the network termination unit 3 can always be monitored from the central exchange 1.

For powering a network termination unit 3 in normal operation, as depicted in FIG. 1, the required power P_{NT}N must be supplied by the central system via the first interface 4. However, a higher power P_{NT}S is required during startup of a network termination unit 3, because typically an input capacitor located in the network termination unit 3 must be charged during startup, which causes increased power consumption during startup.

In the following, U_{S} represents the supply voltage at a specified interface. For example, the supply voltage at the first interface 4 is designated with U_{S}4 and the supply voltage at the second interface 5 described below is designated with U_{S}5.

At a given supply voltage Us, the following currents I_{NT}N and I_{NT}S, respectively, can be calculated from the power required for normal operation P_{NT}N and for startup operation P_{NT}S of a network termination unit 3. It is always I_{NT}S>I_{NT}N. These currents are always determined for a specific supply voltage Us, whereby the supply voltages U_{S}4 and U_{S}5 at the first and second interface 4, 5, respectively, are generally different.

The technical standard TS 102 080 defines the required currents to be provided by remote power via the U interface, when connecting an ISDN network termination unit 3 at a given supply voltage U_{S}.

However, the current that can be supplied via an interface is limited. This limitation relates, on one hand, to the power loss associated with large currents and, on the other hand, to the safety aspects of handling the cables, etc. In the following, the maximum current to be transmitted via an interface will be designated I_{MAX}. Accordingly, I_{MAX}4 and I_{MAX}5 refer to the maximum currents to be transmitted via the first and second interface 4, 5, respectively. The maximum transmitted powers P_{MAX}4 and P_{MAX}5, respectively, can be calculated from the supply voltages U_{S}4 and U_{S}5 at the first and second interface 4, 5, respectively.

When the remote power is supplied by the central exchange 1, as depicted in FIG. 1, sufficient power can be readily supplied to satisfy the increased current requirements during startup of the network termination units 3. For remotely powering the first interface 4, the following inequality holds: I_{MAX}4>I_{NT}S>I_{NT}N. The supply voltage U_{S}4 of the first interface 4 is, for example, approximately 105 V, the maximum current transmitted via the U interface or via the first interface 4 is for example I_{MAX}4=60 mA. This is sufficient for both the operation of the network termination unit 3 which requires at the specified supply voltage U_{S}4 an operating current I_{NT}N of approximately 10 mA, and also for the startup of the network termination unit 3, which requires, for example, a startup current I_{NT}S of approximately 60 mA.

The invention described below with reference to FIGS. 5A and 5B relates to situations where—as shown in FIG. 2—the central unit 2 which remotely powers the local systems 3, for example the network termination units 3, is itself remotely powered. One example of such remotely powered central system is a local unit 2 in employed in the telecommunication industry.

When the network termination unit 3 is remotely powered by a local unit 2 which itself is remotely powered, the remote power supplied to the local unit 2 has to be sufficient to power all network termination units 3 reconnected to the local unit 2. This causes problems in particular when the remotely powered local unit 2 is powered via an interface 5 that can only supply a limited maximum current.

FIG. 2 shows in arrangement where four ISDN network termination units 3 are connected to a local unit 2 via a first interface 4. The local unit 2 itself is connected via a second interface 5, for example a DSL line, with the central exchange 1 or the switching station. The central exchange 1 is connected with the local unit 2, for example, via conventional subscriber lines, where the maximum transmitted current is limited to I_{MAX}5=60 mA. The second interface 5 has, for example, a maximum supply voltage U_{S}5 of±160 V.

The operating power for normal operation P_{NT}N must be reliably remotely supplied via the second interface 5 capable of supplying a maximum current of I_{MAX}5 and a maximum power P_{MAX}5 to each of the n network termination units 3 connected to the local unit 2 via a respective first interface 4. Accordingly, for the specified supply voltages at the interfaces 4, 5, it must hold that P_{MAX}5≧n·P_{NT}N+P₂. The term P₂ hereby indicates the power dissipated in the local unit 2 or its DC converter.

The maximum power P_{MAX}5 that can be transmitted will in the following be understood to represent the maximum input power at the local unit 2. The maximum power P_{MAX}5 is different from the output power P_{MAX}5′ supplied at the central exchange 1 due to the power loss across the interface 5.

In the arrangement depicted in FIG. 2, the operating power of all network termination units 3 can always be maintained by the remote power supplied to the local unit 2. This arrangement is generally designed for the highest number of network termination units 3 to be connected to the local unit 2. Therefore, preferably P_{MAX}5=n·P_{NT}N+P₂. However, it follows that P_{MAX}5<n·P_{NT}S+P₂ or P_{MAX}5<(n−1)·P_{NT}N+P_{NT}S+P₂. In other words, although the operating power for all network termination units 3 can be provided by remotely powering the local unit 2 via the second interface 5, the power available via the second interface 5 during startup of a network termination unit 3 is insufficient for powering the already operating network termination units 3 and simultaneously starting the additional network termination unit 3.

For this reason, conventional local units include an energy storage unit 12 which is charged during the startup of the local unit 2 and/or during the normal operation of the network termination units 3. The stored energy is then discharged for starting the individual network termination units 3.

FIGS. 3A, 3B and 4A, 4B, respectively, show conventional approaches, with the energy storage unit 12 located in the local unit 2. The following figures show only those elements and connections of the local unit 2 which relate to the supply of power in general, and more particularly to the supply of remote power.

FIG. 3A shows a local unit 2 with a power converter 10 with a processing circuit 11 connected downstream. An energy storage unit 12 is connected downstream to the output of the processing circuit 11. The energy storage unit 12 supplies the required startup energy and/or the required startup current I_{NT}S to each individual network termination unit 3. The energy storage unit 12 has to be sized so that at least the startup energy required for starting one network termination unit 3 is stored.

This represents the most favorable situation, where the network termination units 3 are started sequentially and where sufficient time is provided between the start of two network termination units 3 to charge the energy storage unit 12.

In the most unfavorable situation, all network termination units 3 start up simultaneously. In this case, the storage unit 12 has to be large enough so as to supply the required startup energy for starting all the network termination units 3.

In the depicted arrangement, however, each network termination unit 3 is connected with the output of the energy storage unit 12 via a single current path S1. The start of one network termination unit 3 can therefore affect the energy supplied to the remaining network termination units 3. As a result, the supply voltage of the remaining network termination units 3 can collapse during startup of a network termination unit 3, which may switch the already operating network termination units 3 off.

To eliminate this problem, the energy storage unit 12 has to be suitably dimensioned. For example, the supply voltage of the already operating network termination units 3 can be reliably maintained by using sufficiently large capacitors in the energy storage unit 12 and does not collapse when a new network termination unit 3 is started.

FIG. 3B shows a circuit diagram of the afore-described arrangement. The output of the transformer T1 representing the power converter 10 is coupled to the processing circuit 11 formed by a rectifier assembly which includes a diode D1 and a capacitor C1. A current limiter L1, which ensures that the power drained from the remote supply does not exceed a specified level, is provided at the output of the processing circuit 11. The current limiter L1 is dimensioned so that for a specified supply voltage U_{S}4 the power dissipated at the highest acceptable current IL1 is lower than the maximum power P_{MAX}5 supplied on the subscriber lines by the central office. Accordingly, preferably P_{MAX}5≧IL1·U_{S}4+P₂. The current limiter L1 can be implemented, for example, by a constant current source implemented, for example, with a JFET or a FET diode. The energy storage unit 12 is formed by a capacitor C2 which provides enough power for starting the network termination units 3.

The various network termination units 3 can be connected to the energy storage unit 12 via the U interface or via the interface 4. Each terminal has herein its own current limiter L2. The current limiters L2 are matched to the operating parameters of the network termination units 3, in particular the supply voltage. The current limiters L2 are preferably controllable. For example, for a given supply voltage U_{S}4, the current can be limited in normal operation with respect to the required operating power P_{NT}N, or during startup with respect to the startup power P_{NT}S, of a network termination unit 3. Moreover, a current may be prevented from flowing to the network termination units 3 at the startup of the local unit 2, corresponding to a current limit in this phase of 0 mA (I0). The highest current IL2 permitted by the current limiter L2 can therefore be set, for example, to the values IL2=I_{NT}N, IL2=I_{NT}S and IL2=I0 (0 mA).

It can be seen from the circuit diagram depicted in FIG. 3B that the capacitor C2 is discharged when a network termination unit 3 is started, with the voltage at point P1 collapsing. This may lead to a situation where the supply voltage of the already started network termination units 3 cannot be maintained. This can only be prevented by providing an oversized capacitor C2. The same applies when two or more network termination units start simultaneously, also requiring an oversized capacitor C2.

FIG. 4A shows another local unit 2 with a power converter 10 and a processing circuit 11 connected downstream. Unlike the arrangement depicted in FIG. 3A, a dedicated energy storage unit 12 for each network termination unit 3 is connected to the output of the processing circuit 11. Each of the energy storage units 12 supplies the required startup energy for the corresponding network termination unit 3 connected downstream.

With this arrangement, the power supplies of the individual network termination units 3 are decoupled. The startup of a network termination unit 3 can therefore no longer affect the power supply of the remaining network termination units 3. The supply voltage of the already started network termination units 3 is then always maintained.

Disadvantageously, a dedicated energy storage device 12 has to be provided for each network termination unit 3, which increases the costs. FIG. 4B shows a circuit diagram corresponding to the arrangement of FIG. 4A. The power converter 10 and the processing circuit 11 are here also formed by a transformer T1, a diode D1 and a capacitor C1.

Each network termination unit 3 includes a dedicated current limiter L3, which is connected to the output of the processing circuit 11 in FIG. 4B and is set to the operating states of the individual network termination units 3. Accordingly, preferably IL3=I_{NT}N. In this way, the required difference between the operating current I_{NT}N and the startup current I_{NT}S during startup of a network termination unit 3 can only be supplied by the corresponding capacitor C2 and does not flow through the current limiters L3. This prevents a decrease in the potential at the point P2 when a network termination unit 3 starts up.

By connecting a current limiter L3 upstream of each connected network termination unit 3, as shown in FIG. 4B, the consumed remote power cannot exceed the level defined by the sum of the current limiters L3 for a given supply voltage U_{S}4. The current limiters ensure that the consumed remote power is less than P_{MAX}5. Accordingly, P_{MAX}5≧n·IL3·U_{S}4+P₂ with IL3=I_{NT}N.

The individual energy storage units 12 are each formed by a respective capacitor C2 which provides power for starting a network termination unit 3. The capacitors C2 are charged when starting the local unit 2. For this purpose, a switch 20 is provided for each network termination unit 3. These switches 20 are initially open when the local unit 2 is started so that the capacitors C2 can be charged. The switches 20 are closed only after all capacitors C2 have been charged for starting the various network termination units 3. A control unit 21 controls the switches 20. The control unit 21 can be implemented, for example, with a microcontroller. Advantageously, the control unit 21 closes the switches 20 only after a specified time interval following the start of the local unit 2, with the time determined by the charging time of the capacitors C2. After this time interval has passed, the switches 20 are closed to start the individual network termination units 3, with the capacitors C2 providing the necessary startup power.

By decoupling the power supply from the individual network termination units 3 as depicted in FIG. 4B, the supply voltage of the already started network termination units 3 can be maintained and is not affected when an additional network termination unit 3 is started. However a dedicated capacitor C2 must be supplied for each network termination unit 3, i.e., n capacitors C2 are required for n network termination units 3.

It would therefore be desirable and advantageous to provide an improved circuit arrangement for remotely powering local systems, such as network termination units, from a central unit which itself is remotely powered, which obviates prior art shortcomings and is able to reliably provide the startup energy for startup of the local systems, while keeping the overall size of the central unit small.

### SUMMARY OF THE INVENTION

According to one aspect of the invention, a circuit arrangement for remotely powering a plurality of local systems, such as network termination units, includes a power converter receiving remote power from a central exchange, a processing circuit connected downstream of the power converter and providing a supply voltage to the plurality of local systems via a first current path, an energy storage unit for providing a startup energy of the plurality of local systems, and a plurality of switches arranged between the energy storage unit and the plurality of local systems, wherein each switch electrically connects a different one of the plurality of local systems to the energy storage unit via a second current path.

This arrangement prevents mutual interactions between the power supply paths of the local systems. This arrangement also allows the use of small capacitors, which results in a small installation size and therefore an inexpensive fabrication.

According to one advantageous feature of the invention, a control circuit can be employed to control the plurality of switches. In this way, the switches are automatically controlled so that the energy storage unit is always completely charged before a new network termination unit is started.

According to yet another feature of the invention, the control circuit can include a timing circuit, which represents a particularly simple control device. By waiting for a fixed predetermined time sufficient to charge the energy storage unit, sufficient startup energy can be reliably supplied for starting the next network termination unit.

According to another advantageous feature of the invention, the control unit can be implemented by a microprocessor. This allows a particularly accurate control the switches based on the state of the local unit and/or the energy storage unit.

According to another feature of the invention, the control circuit can be connected to an output of the energy storage unit, which can shorten the time before the next network termination unit can be started, if the energy storage unit is not completely discharged, as compared to the time required to completely recharge the energy storage unit.

According to yet another advantageous feature of the invention, the energy storage unit can be connected to the power converter and a decoupling element can be arranged between the energy storage unit and an output of the power converter or the processing circuit. The energy storage unit can hereby be charged in particularly simple manner via the power converter and the decoupling element, obviating the need for additional DC converters. This approach prevents a collapse of the supply voltage of the remaining network termination units during startup of another network termination unit.

According to another feature of the invention, the decoupling element can be a resistor, which represents a particularly simple and inexpensive decoupling element.

According to yet another feature of the invention, the decoupling element can be a current limiter configured to prevent the total current flowing via all the first current paths from exceeding a maximum allowable value.

According to another feature of the invention, the decoupling element can be controllable. For example, the decoupling element can be controlled independent of the actual state of the local unit or the number of the already started network termination units. For example, the controllable decoupling element can be controlled so that the energy storage unit is more rapidly charged at the beginning, i.e., before any network termination units are started. For example, the controllable decoupling element can also be controlled by the control unit.

According to another feature of the invention, the control unit is connected with a measuring unit that measures the power that can be received by the energy converter. In this way, the decoupling element can be controlled depending on the actually available power. The charging time of the energy storage device can thereby be further reduced or at least optimized with respect to the available power.

According to still another feature of the invention, the switches can be implemented as MOSFETs which are simple and can be switched with no or at most insignificant losses.

According to another aspect of the invention, a method is provided for remotely powering a plurality of local systems, such as network termination units, from a local unit which itself is remotely powered from a central exchange. The local unit has a circuit arrangement which includes a power converter receiving remote power from a central exchange, a processing circuit connected downstream of the power converter and providing a supply voltage to the plurality of local systems via a first current path, an energy storage unit for providing a startup energy of the local systems, and a plurality of switches arranged between the energy storage unit and the local systems. Each switch electrically connects a different one of the local systems to the energy storage unit via a second current path. The method includes the steps of opening all switches when the central system or the local unit is started, charging the energy storage unit, closing the switches associated with the local systems one at a time to successively connect a local system with the energy storage unit for successively starting the local system, and recharging the energy storage unit before each of the successive starting operations. In this way, sufficient startup energy can be provided for starting the next network termination unit.

According to another feature of the invention, the method further includes the steps of determining the charging state of the energy storage unit and determining from the charging state a time interval between two successive starting operations. The next network termination unit can then be started very quickly, i.e., immediately after the energy storage device has reached the required energy level.

According to another feature of the invention, the energy storage unit can be particularly easily charged via a decoupling element arranged between the energy storage unit and an output of the power converter or the processing circuit.

According to yet another feature of the invention, the remote power available from the central exchange power can be determined and the decoupling element can be controlled based on the determined available power. This way, the charging time of the energy storage device can be minimized depending on the available power.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram depicting several local systems remotely powered by a central exchange;

FIG. 2 is a schematic diagram depicting several local systems remotely powered by a remotely powered local system;

FIG. 3A is a simplified block diagram of a local system with an energy storage unit;

FIG. 3B is a circuit arrangement corresponding to the block diagram of FIG. 3A;

FIG. 4A is a simplified block diagram of a local system with several energy storage units;

FIG. 4B is a circuit arrangement corresponding to the block diagram of FIG. 4A;

FIG. 5A is a simplified block diagram of a local system with an energy storage unit according to the invention; and

FIG. 5B is a circuit arrangement according to the invention corresponding to the block diagram of FIG. 5A.

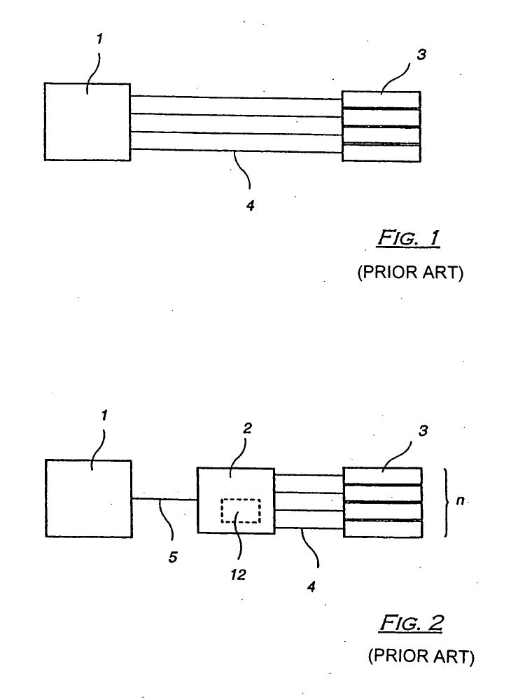

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In specified instances, details which are not necessary for an understanding of the present invention or which render other details difficult to perceive may have been omitted.

The invention relates to remotely powering local systems used in the telecommunication industry from a central unit, whereby the central unit itself is remotely powered. The local system, when remotely powered, does not depend on the local power supply, but is instead powered by the central unit. The local system can then advantageously always be checked and maintained by the central unit when a local power supply is not available.

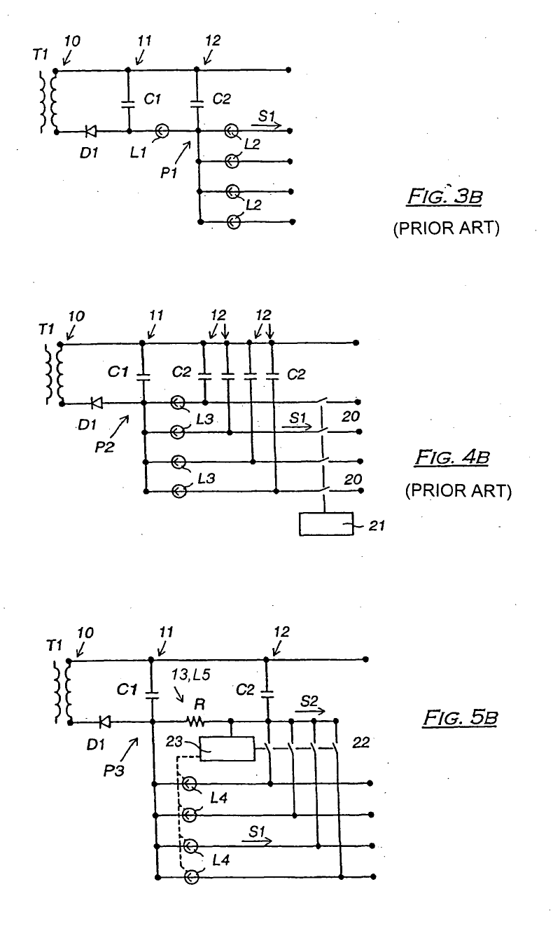

Turning now to FIGS. 5A and 5B, there is shown a circuit arrangement according to the invention for remotely supplying power to several local systems from a central unit that is itself remotely powered by a central exchange.

The present invention provides significant improvements as compared to the afore-described conventional embodiments. The power supplies of the individual network termination units 3 are reliably decoupled, while requiring only a single energy storage device 12. The unit can therefore have a correspondingly small size.

FIG. 5A shows the difference between a local unit 2 according to the invention and the afore-described conventional solutions. Advantageously, only a single energy storage device 12 has to be provided at the output of the processing circuit 11. The energy storage device 12 can be selectively connected to any network termination unit 3 and hereby provide the required power via a second current path S2 for starting the network termination unit 3. During normal operation, power is supplied to the network termination units 3 via respective first current paths S1.

The energy storage device 12 can be charged in different ways, for example via a dedicated second DC converter.

In FIG. 5A, a decoupling element 13 which decouples the energy storage device 12 from the output of the power converter 10 or the processing circuit 11, is provided for charging the energy storage unit 12. The decoupling element 13 performs two functions. On one hand, the decoupling element 13 can be used to charge the energy storage device 12. On the other hand, the decoupling element 13 prevented a collapse of the supply voltage of the remaining network termination units 3 when the energy storage device 12 is discharged during startup of a network termination unit 3. The power supplies of the individual network termination units 3 are thereby decoupled. Accordingly, the startup of a network termination unit 3 can no longer affect the power supplied to the remaining network termination units 3. The supply voltage of the already started network termination units 3 is therefore always maintained.

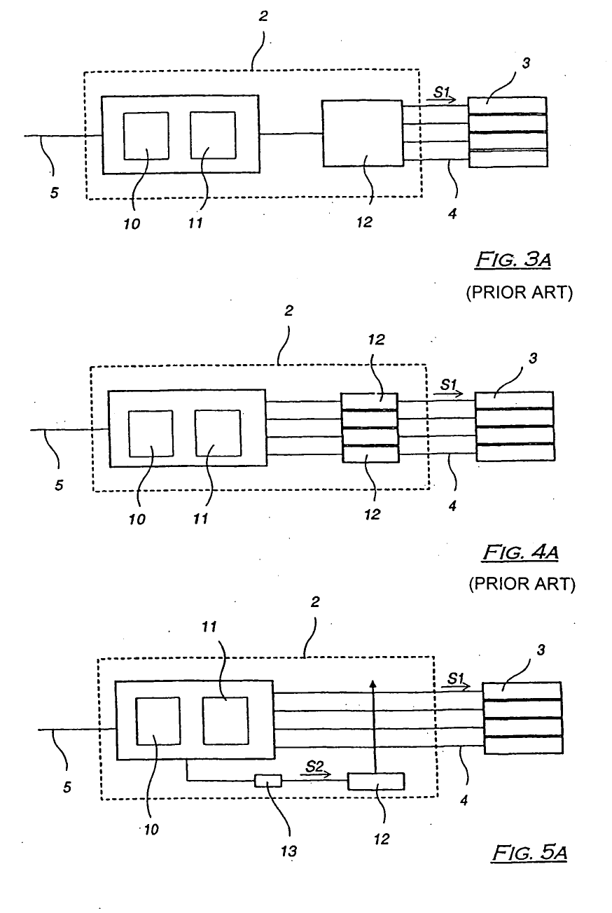

The energy storage device 12 can therefore be much smaller than the energy storage device 12 of FIG. 3A, since it needs only to supply the current I_{NT}S required for starting a single network termination unit 3. Unlike in the arrangement depicted in FIG. 4A, only a single energy storage device 12 is required.

FIG. 5B shows a circuit diagram corresponding to the arrangement according to the invention. Like the arrangement depicted in FIGS. 3A and 4A, the power converter 10 and the processing circuit 11 are again formed by a transformer T1, a diode D1 and a capacitor C1. However, the invention is not limited to these embodiments. Different types of converters, such as DC converters, etc., can be used. In addition, special rectifiers circuits, such as Delon rectifiers circuits, can be employed, as well as other conventional signal processing methods.

A dedicated current limiter L4 for each network termination unit 3 is again provided at the output of the processing circuit 11. The current limiter L4 is preferably set with IL4=I_{NT}N to the operating state of the individual network termination units 3. In this way, the upper power limit P_{MAX}5 of the subscriber line, corresponding to the sum of the currents I_{NT}N flowing at a given supply voltage U_{S}4, is not exceeded when all network termination units 3 are started. The current limiters L4 can be implemented as a constant current source, as described above. They can be controllable or not controllable. In normal operation, the network termination units 3 are powered via the current paths S1 through the current limiters L4, as indicated in FIG. 5B.

Although, current limiters L4 are preferred, the current limiters L4 can also be eliminated to provide a more compact unit. The current limiters L4 are preferably controllable. This has the advantage that, when the local unit 2 is initially started, no current flows through the current limiters L4 and therefore the energy storage units 12 or the capacitor C2 are charged more rapidly. The current limiters L4 can be controlled to the threshold values IL4=I0 and IL4=I_{NT}N. In FIG. 5B, the current limiters L4 are connected with the control unit 23.

The current limiters can also be combined with switches 20 (not shown in FIG. 5B), which like the arrangement depicted in FIG. 4B, establish a connection only when the corresponding network termination unit 3 is started. The operation is thus similar to the afore-described controllable current limiters L4. In principle, any combination of controllable current limiters L4 and switches 22 can be used.

The energy storage device 12 is again formed by a capacitor C2, which supplies the energy for starting a network termination unit 3. The energy storage device 12 can be formed by a single capacitor C2 or by a capacitor circuit with several cooperating components. The capacitor C2 is connected with the output of the processing circuit 11 via the decoupling element 13, which in FIG. 5B is formed by a resistor R. The resistor R represents a decoupling element 13 according to the invention. When the local unit 2 is started, the energy storage device 12 is charged via the resistor R.

If the voltage at the capacitor C2 collapses during the startup of a new network termination unit 3, the voltage difference across the resistor R prevents a decrease in the voltage at point P3. The capacitor C2 is hence decoupled by the resistor R from the supply voltage of the network termination units 3 according to the invention.

The resistor R represents the simplest form of a decoupling element 13 according to the invention. Another type of decoupling element 13 can be, for example, one of the afore-described current limiters, hereinafter indicated by the reference character L5. The capacitor C2 can be charged and the startup of the local unit 2 via the current limiter L5. When a network termination unit 3 is started, the current limiter L5 prevents the voltage at the point P2 from decreasing below the value required for powering the already started network termination units 3.

The capacitor C2 depicted in FIG. 5B can be connected via the switches 22 with the terminals for the network termination units 3. The switches 22 are closed only for starting a corresponding network termination unit 3. During startup of a network termination unit 3, the current I_{NT}S required for the startup can be supplied by the capacitor C2 via a second current path S2. If the corresponding current limiter L4 is set to the threshold value IL4=I_{NT}N, then only the difference between I_{NT}S and I_{NT}N has to be supplied by the capacitor C2. After the startup, the corresponding switch 22 can be opened again. Power to the started network termination unit 3 is supplied via the lines with the current limiters L4, or via the first current path S1.

The capacitor C2 can subsequently be recharged via the resistor R by opening the switch 22 and used to start an additional network termination unit 3.

If neither a decoupling element 13 nor a resistor R is provided, then the capacitor has to be charged in another way, for example via an additional DC converter.

The switch 22 is preferably implemented as a MOSFET. However, other types of switches, such as relays, are feasible. The switch 22 can also be implemented as a controllable current limiter, as described above, which can be controlled between the limit currents 10 and the startup current I_{NT}S.

It is important with the arrangement of the invention that the energy storage unit 12 or the capacitor C2 is only connected with one network termination unit 3 at one time.

Preferably, all switches 22 are open when the local unit 2 is started or during normal operation, i.e., during operation with all the already started network termination units 3. This state is also depicted in FIG. 5B.

After the start of the local unit, all network termination units 3 are sequentially connected to the energy storage unit 12, which sequentially starts the network termination units 3. A specified time interval has to be maintained between the start of the various network termination units 3, so that the energy storage unit 12 can be recharged.

The switches 22 are controlled by the control unit 23, as depicted in FIG. 5B. This can be accomplished with a microcontroller, or with other conventional control devices, such as memory-programmable controllers or ASICs. The control unit 23 also ensures that only one of the switches 22 is closed at one time. More demanding controlled tasks can be preferably performed by a microprocessor.

In a simple control process of switch 22, a simple time window can be employed. For example, the capacitor C2 can be initially connected for a time interval Tₛ, for example for 1.5 seconds, to the first network termination unit 3 via a second current path S2. The corresponding switch 22 is then again opened, disconnecting the capacitor C2 from the first network termination unit 3. After a fixed predetermined time delay T_{L} sufficient for charging the capacitor C2, the capacitor C2 is connected to the second network termination unit 3, and so on.

Alternatively, the control can depend on the charge state of the energy storage unit 12 or the capacitor C2. For this purpose, the control unit 23 in FIG. 5A is connected to the output of the energy storage unit 12. The control unit 23 can establish a connection with the next network termination unit 3 depending on the voltage at the output of the capacitor C2. The charging times can be optimized based on a measured charge state of the capacitor C2. For example, smaller input capacitances of the network termination units 3 require shorter time intervals before the start of the next network termination unit 3.

In another advantageous embodiment, the decoupling element 13 itself can be controllable and can be controlled depending on the respective state of the local unit 2, in particular depending on the available power in the local unit 2, for example depending on the number of the already started network termination units 3. For this purpose, the controllable decoupling element 13 is preferably connected to the control unit 23. Normally, the decoupling element 13 is dimensioned so that the voltage drop at the decoupling element 13 is sufficient to prevent the voltage at the point P3 to fall below the required to supply voltage for the already operating network termination units 3, even in the event of the short-circuit in the network termination unit 3. The charging time of the capacitor C2 should also be kept as short as possible. A fixed value should be selected for a constant, i.e. not controllable, decoupling element 13.

A controllable decoupling element can be changed depending on the state of the local unit 2. An advantageous embodiment of a controllable decoupling element 13 will now be described with reference to a controllable current limiter L5. A controllable decoupling element 13 according to the invention can also be implemented as a variable resistor and the like.

If the decoupling element 13a is implemented as a controllable current limiter L5, then the current limiter can be set at the start of the local unit 2 to the maximum current for L5 for which the maximum power P_{MAX}5 to be transmitted via the interface 5 is not exceeded. Accordingly, for a defined supply voltage U_{S}4: P_{MAX}5=IL5*U_{S}4+P₂. All controllable current limiters L4 are simultaneously set to IL4=0 mA. The capacitor C2 can then be charged in the shortest possible time. After the capacitor C2 has been charged, the current limiter L5 can be set to a low of value of IL5 for the subsequent start of the first network termination unit 3. This takes into account that in addition to the current IL5 an additional current I_{NT}N flows through the current limiter L4 associated with the first network termination unit 3 during and after the start of the first network termination unit 3. Accordingly, the maximum current IL5 must be reduced by I_{NT}N. When the second network termination unit 3 is started, the maximum current IL5 is reduced by 2*I_{NT}N, when the third unit 3 is started, by 3*I_{NT}N, and so on.

If the decoupling element 13 were not controllable, then the lowest value would always have to be set for IL5, corresponding to P_{MAX}5=(IL5+n*I_{NT}N)*U_{S}4+P₂. This would result in a longer charging time of the capacitor C2. The lowest value for IL5 is obtained according to FIG. 5B when three network termination units 3 are operating and one network termination unit 3 is just starting, in which case the total current flowing through the current limiters L4 is n*I_{NT}N with n=4.

Conversely, with the afore-described control, the charging time of the capacitor C2 can be substantially reduced. Likewise, the total duration of the startup process can also be significantly reduced by switching the network termination units 3 with the control unit 23 as a function of the voltage.

In addition, the current limiter L5 can be set to a higher value only for charging the capacitor C2 and reduced to a value of IL5=10 (0 mA) immediately at the startup of a network termination unit 3. This decouples the point P3 from the energy storage unit 12 in a particularly efficient manner.

Advantageously, the decoupling element 13 can be controlled depending on the actually available power P_{MAX}5 on the subscriber line, or for a given supply voltage U_{S}5 depending on I_{MAX}5. The control unit 23 can then be connected with a measuring device (not shown) which measures the power P_{MAX}5 or the current I_{MAX}5 available via the interface 5. The maximum current flowing via the controllable decoupling element 13 or via the current limiter L5 can be set to match the actually available current I_{MAX}5, preferably in the afore-described manner. This approach is advantageous because the actually available power P_{MAX}5 does not correspond to the known power P_{MAX}5′ at the output of the central exchange 1, but is lower due to power losses. Accordingly, P_{MAX}5 is affected by different parameters, such as the line length and the line resistance of the interfaces 5, and can vary considerably. By controlling the decoupling element 13 depending on the actual available power P_{MAX}5, the maximum current can always be provided for charging the capacitor C2 without risking a collapse of the supply voltage at the remaining network termination units 3.

By decoupling the energy storage unit 12 from the supply of the individual network termination units 3 according to the invention, the operating voltage of the already started network termination units 3 can always be maintained and is not affected by the startup of an additional network termination unit 3. With the arrangement of the invention, only a relatively small energy storage unit 12 is required.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A circuit arrangement for remotely powering a plurality of local systems, comprising:
a power converter receiving remote power from a central exchange;
a processing circuit connected downstream of the power converter and providing a supply voltage to the plurality of local systems via a first current path;
an energy storage unit for providing a startup energy of the plurality of local systems; and
a plurality of switches arranged between the energy storage unit and the plurality of local systems, wherein each switch electrically connects a different one of the plurality of local systems to the energy storage unit via a second current path.

2. The circuit arrangement of claim 1, wherein the local systems comprise network termination units.

3. The circuit arrangement of claim 1, and further comprising a control circuit for controlling the plurality of switches.

4. The circuit arrangement of claim 3, wherein the control circuit comprises a timing circuit.

5. The circuit arrangement of claim 3, wherein the control circuit comprises a microprocessor.

6. The circuit arrangement of claim 3, wherein the control circuit is connected to an output of the energy storage unit.

7. The circuit arrangement of claim 1, wherein the energy storage unit is connected to the power converter and further including a decoupling element arranged between the energy storage unit and an output of the power converter or the processing circuit.

8. The circuit arrangement of claim 7, wherein the decoupling element comprises a resistor.

9. The circuit arrangement of claim 7, wherein the decoupling element comprises a current limiter.

10. The circuit arrangement of claim 7, wherein the decoupling element is controllable.

11. The circuit arrangement of claim 10, and further comprising a control circuit for controlling the plurality of switches and the controllable decoupling element.

12. The circuit arrangement of claim 11, wherein the control unit is connected to a measuring unit that measures a power received by the energy converter.

13. The circuit arrangement of claim 1, wherein the switches are formed by MOSFETs.

14. A method for remotely powering a plurality of local systems from a local unit which itself is remotely powered from a central exchange, said local unit having a circuit arrangement which includes a power converter receiving remote power from a central exchange, a processing circuit connected downstream of the power converter and providing a supply voltage to the plurality of local systems via a first current path, an energy storage unit for providing a startup energy of the plurality of local systems, a plurality of switches arranged between the energy storage unit and the plurality of local systems, wherein each switch electrically connects a different one of the plurality of local systems to the energy storage unit via a second current path, the method comprising the steps of:
opening all switches when the central system or the local unit is started;
charging the energy storage unit;
closing the switches associated with the local systems one at a time to successively connect a local system with the energy storage unit for successively starting the local system; and
recharging the energy storage unit before each of the successive starting operations.

15. The method of claim 14, wherein the local systems comprise network termination units.

16. The method of claim 14, and further comprising the steps of determining the charging state of the energy storage unit and determining from the charging state a time interval between two successive starting operations.

17. The method of claim 14, wherein the energy storage unit is charged via a decoupling element arranged between the energy storage unit and an output of the power converter or the processing circuit.

18. The method of claim 17, and further comprising the steps of determining the remote power available from the central exchange power and controlling the decoupling element based on the determined available power.
